(19) United States
(12) Patent Application Publication
(10) Pub. No.: US 2026/0267455 A1
(43) Pub. Date: Sep. 10, 2026

(54) ELECTRONIC OPERATION SYSTEM, BRACELET MOUSE, AND DETECTION MACHINE OF BRACELET MOUSE

(71) Applicant: DEXIN CORPORATION, New Taipei City (TW)

(72) Inventors: HO-LUNG LU, NEW TAIPEI CITY (TW); YI-FAN LIU, New Taipei City (TW)

(21) Appl. No.: 19/208,569

(22) Filed: May 14, 2025

(30) Foreign Application Priority Data
Mar. 6, 2025 (TW) 114108217

(51) Int. Cl. G06F 3/04812; G06F 1/16; G06F 3/01; G06F 3/0354

(52) U.S. Cl. CPC G06F 3/04812; G06F 1/163; G06F 3/015; G06F 3/017; G06F 3/03543

(57) ABSTRACT

An electronic operation system, a bracelet mouse, and a detection machine of a bracelet mouse. The detection machine includes a housing, an electromyography (EMG) sensor assembled in the housing, and a motion sensor that is assembled to the housing. The housing has an outer wrist segment and an ulna segment that is connected to the outer wrist segment. A wearing angle between the outer wrist segment and the ulna segment is within a range from 80 degrees to 100 degrees. The EMG sensor faces toward an inner side of the housing for detecting a user's gestures, and the motion sensor is assembled in the ulna segment and faces toward an outer side of the housing. The ulna segment is configured to move on a working surface, and the motion sensor is configured to obtain a movement path of the ulna segment on the working surface.

### CROSS-REFERENCE TO RELATED PATENT APPLICATION

This application claims the benefit of priority to Taiwan Patent Application No. 114108217, filed on Mar. 6, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a mouse, and more particularly to an electronic operation system, a bracelet mouse, and a detection machine of a bracelet mouse.

### BACKGROUND OF THE DISCLOSURE

Although conventional mice are provided in many different types, the basic structure of the conventional mouse is still built around requiring palm pressure to control, such that users cannot free their hands while controlling the conventional mouse.

### SUMMARY OF THE DISCLOSURE

In response to the above-referenced technical inadequacies, the present disclosure provides an electronic operation system, a bracelet mouse, and a detection machine of a bracelet mouse for effectively improving on the issues associated with conventional mice.

In order to solve the above-mentioned problems, one of the technical aspects adopted by the present disclosure is to provide an electronic operation system, which includes a bracelet mouse, a processing device, and a display. The bracelet mouse includes a detection machine and a wristband. The detection machine includes a housing, an electromyography (EMG) sensor, and a motion sensor. The housing has an outer wrist segment and an ulna segment connected to the outer wrist segment. A wearing angle between the outer wrist segment and the ulna segment is within a range from 80 degrees to 100 degrees. The EMG sensor is assembled in the housing and faces toward an inner side of the housing. The motion sensor is assembled in the ulna segment and faces toward an outer side of the housing. The wristband is detachably assembled to the outer wrist segment and the ulna segment of the housing. The bracelet mouse is configured to be worn on a wrist of a user through the outer wrist segment and the wristband so as to enable the ulna segment and the motion sensor to be located adjacent to an ulna of the wrist. When the bracelet mouse is worn on the wrist, the EMG sensor is configured to detect gesture changes of the user, the ulna segment is configured to move on a working surface along a movement path, and the motion sensor is configured to obtain the movement path. The processing device is wirelessly connected to the EMG sensor and the motion sensor of the bracelet mouse. The display is electrically coupled to the processing device. When the bracelet mouse is worn on the wrist, the processing device is configured to control a cursor of the display through the EMG sensor and the motion sensor.

In order to solve the above-mentioned problems, another one of the technical aspects adopted by the present disclosure is to provide a bracelet mouse that includes a detection machine and a wristband. The detection machine includes a housing, an electromyography (EMG) sensor, and a motion sensor. The housing has an outer wrist segment and an ulna segment connected to the outer wrist segment. A wearing angle between the outer wrist segment and the ulna segment is within a range from 80 degrees to 100 degrees. The EMG sensor is assembled in the housing and faces toward an inner side of the housing. The motion sensor is assembled in the ulna segment and faces toward an outer side of the housing. The wristband is detachably assembled to the outer wrist segment and the ulna segment of the housing. The bracelet mouse is configured to be worn on a wrist of a user through the outer wrist segment and the wristband so as to enable the ulna segment and the motion sensor to be located adjacent to an ulna of the wrist. When the bracelet mouse is worn on the wrist, the EMG sensor is configured to detect gesture changes of the user, the ulna segment is configured to move on a working surface along a movement path, and the motion sensor is configured to obtain the movement path.

In order to solve the above-mentioned problems, yet another one of the technical aspects adopted by the present disclosure is to provide a detection machine of a bracelet mouse that includes a housing, an electromyography (EMG) sensor, and a motion sensor. The housing has an outer wrist segment and an ulna segment connected to the outer wrist segment. A wearing angle between the outer wrist segment and the ulna segment is within a range from 80 degrees to 100 degrees. The EMG sensor is assembled in the housing and faces toward an inner side of the housing. The motion sensor is assembled in the ulna segment and faces toward an outer side of the housing.

Therefore, the detection machine of the bracelet mouse in the present disclosure is provided with the housing having the wearing angle for being easily worn on the wrist of the user, so that the user can control the bracelet mouse by using the wrist for freeing both hands.

Moreover, the bracelet mouse in the present disclosure not only includes the EMG sensor, but also includes the motion sensor assembled to the ulna segment that is movable on the working surface, so that the bracelet mouse (or the detection machine) can be operated through the gesture changes of the user and the movement path of the ulna segment.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an electronic operation system when a bracelet mouse is in a mouse control mode according to a first embodiment of the present embodiment;

FIG. 2 is a schematic perspective view of the electronic operation system when the bracelet mouse is in a gesture control mode according to the first embodiment of the present embodiment;

FIG. 3 is a schematic perspective view of the bracelet mouse of FIG. 1;

FIG. 4 is a schematic planar view of the bracelet mouse of FIG. 3;

FIG. 5 is a schematic exploded view of the bracelet mouse of FIG. 3;

FIG. 6 is a schematic perspective view showing the bracelet mouse of FIG. 1 when a wristband is disassembled from a detection machine;

FIG. 7 is a schematic perspective view of the bracelet mouse according to a second embodiment of the present embodiment;

FIG. 8 is a schematic planar view of the bracelet mouse of FIG. 7;

FIG. 9 is a schematic perspective view showing a first position of the bracelet mouse in use according to the second embodiment of the present embodiment; and

FIG. 10 is a schematic perspective view showing a second position of the bracelet mouse in use according to the second embodiment of the present embodiment.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

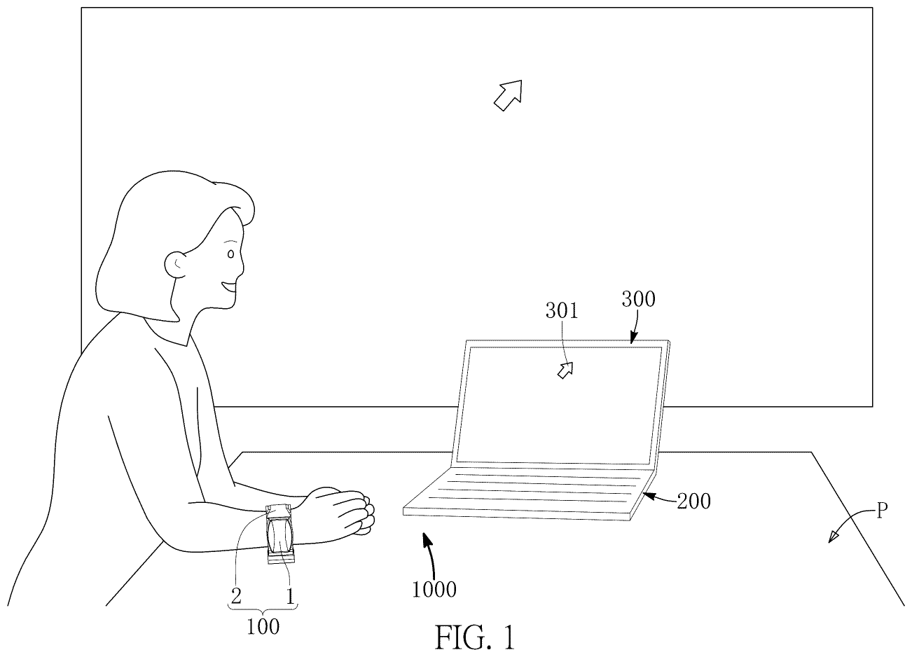

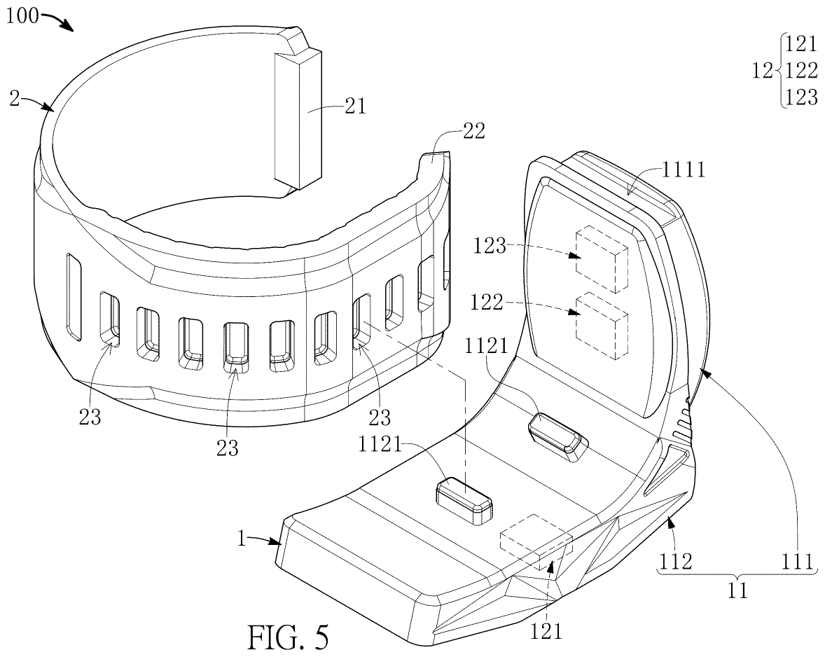

Referring to FIG. 1 to FIG. 6, a first embodiment of the present disclosure is provided. As shown in FIG. 1 to FIG. 3, the present embodiment provides an electronic operation system 1000, which includes a bracelet mouse 100, a processing device 200 wirelessly connected to the bracelet mouse 100, and a display 300 that is electrically coupled to the processing device 200. The bracelet mouse 100 is in cooperation with the processing device 200 for jointly controlling a cursor 301 of the display 300.

It should be noted that the bracelet mouse 100 of the electronic operation system 1000 in the present embodiment is described in cooperation with the processing device 200 and the display 300, but the present disclosure is not limited thereto. For example, in other embodiments of the present disclosure not shown in the drawings, the bracelet mouse 100 can be independently used (e.g., sold) or can be used in cooperation with other components. The following description describes the structure and connection relationship of each of the bracelet mouse 100, the processing device 200, and the display 300.

The bracelet mouse 100 in the present embodiment is worn on a wrist of a user; in other words, any mouse being not worn on a user's wrist is different from the bracelet mouse 100 provided by the present embodiment. Moreover, the bracelet mouse 100 includes a detection machine 1 and a wristband 2 that is detachably assembled to the detection machine 1, but the present disclosure is not limited thereto. For example, in other embodiments of the present disclosure not shown in the drawings, the detection machine 1 can be independently used (e.g., sold) or can be used in cooperation with other components.

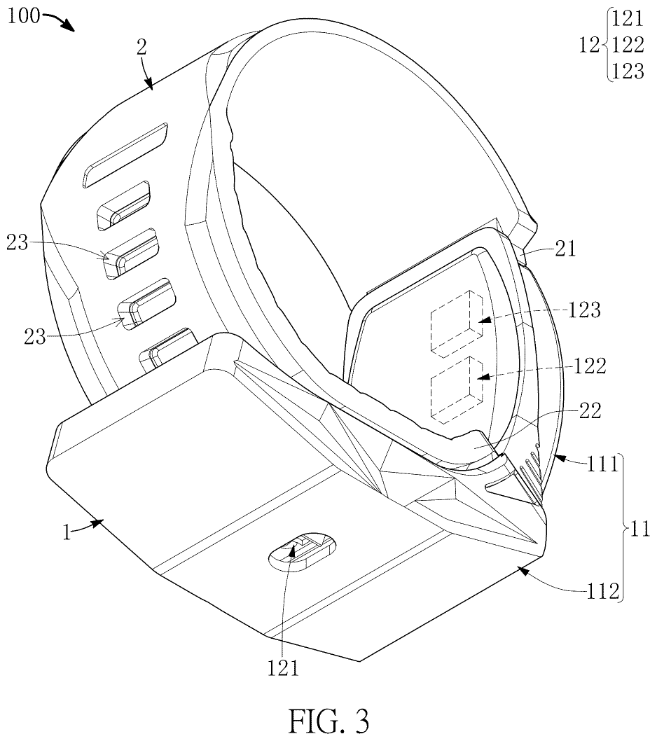

As shown in FIG. 3 to FIG. 5, the detection machine 1 includes a housing 11 and a sensing module 12 that is assembled to the housing 11, and the detection machine 1 can further include other electronic components assembled to the housing 11 according to practical requirements, but the present disclosure is not limited thereto. The housing 11 is substantially L-shaped and has an outer wrist segment 111 and an ulna segment 112 that is connected to the outer wrist segment 111. A wearing angle σ11 between the outer wrist segment 111 and the ulna segment 112 is within a range from 80 degrees to 100 degrees.

Moreover, the wristband 2 is detachably assembled to the outer wrist segment 111 and the ulna segment 112 of the housing 11, and the detection machine 1 is in cooperation with the wristband 2 through the wearing angle σ11, so that the bracelet mouse 100 can be worn on the wrist of the user through the outer wrist segment 111 and the wristband 2. In other words, a configuration of the bracelet mouse 100 is based on the wearing angle σ11, so that when the bracelet mouse 100 is worn on the wrist, the ulna segment 112 is located adjacent to (or is in contact with) an ulna of the wrist, and the outer wrist segment 111 is located adjacent to (or is in contact with) an outer side of the wrist.

It should be noted that an assembling manner between the detection machine 1 and the wristband 2 can be adjusted or changed according to practical requirements. In order to clearly describe the present embodiment, the following description describes one possible example of the detection machine 1 and the wristband 2, but the present disclosure is not limited thereto.

The outer wrist segment 111 has an assembling slot 1111 arranged away from the ulna segment 112, and the ulna segment 112 has at least one positioning protrusion 1121 arranged on an inner side thereof. The wristband 2 has an arced elongated shape, and the wristband 2 has a first end portion 21, a second end portion 22 being opposite to the first end portion 21, and a plurality of adjustment holes 23 that are arranged along a direction from the second end portion 22 toward the first end portion 21.

The first end portion 21 is detachably assembled to the assembling slot 1111 of the outer wrist segment 111, and the at least one positioning protrusion 1121 of the ulna segment 112 is detachably assembled to at least one of the adjustment holes 23, thereby enabling the bracelet mouse 100 to be properly worn on the wrist of the user.

Specifically, the at least one positioning protrusion 121 provided by the present embodiment is further limited to be two positioning protrusions 121 that are detachably assembled to any two of the adjustment holes 23, but the present disclosure is not limited thereto. One of the two positioning protrusions 1121 is adjacent to the outer wrist segment 111 and is slanted relative to another one of the two positioning protrusions 1121, and a positioning angle σ1121 between extension directions of the two positioning protrusions 1121 is less than or equal to 45 degrees, thereby enabling the ulna segment 112 and the wristband 2 to be firmly engaged with each other.

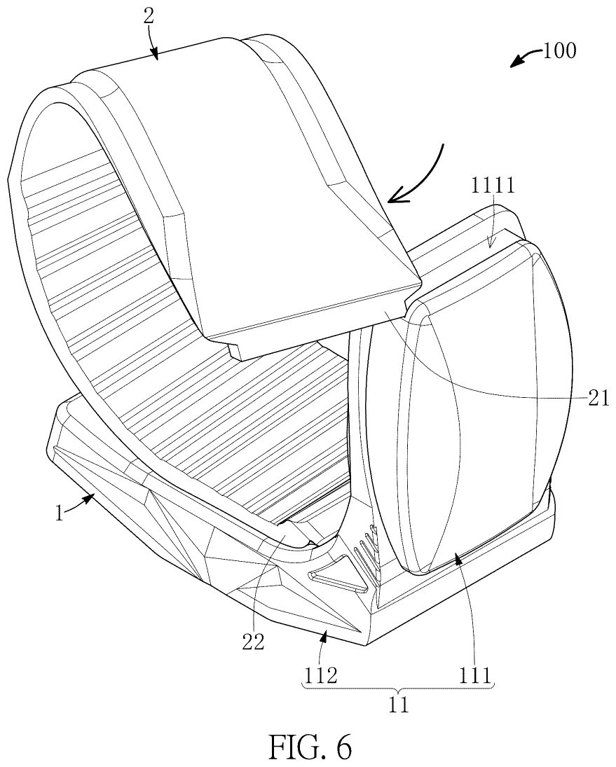

In addition, after the bracelet mouse 100 is worn on the wrist of the user for a first time, the wristband 2 is connected to the at least one positioning protrusion 1121 of the ulna segment 112 through a suitable one of the adjustment holes 23 according to a size of the wrist, so that the first end portion 21 of the wristband 2 can be used to disassemble from the assembling slot 1111 of the outer wrist segment 111 (as shown in FIG. 6) for wearing the bracelet mouse 100 in the future, thereby allowing the user to quickly wear the bracelet mouse 100.

In other embodiments of the present disclosure not shown in the drawings, the bracelet mouse 100 can be provided with functional components (e.g., a movement of a watch) assembled to the outer wrist segment 111 according to practical requirements, thereby increasing the added value of the bracelet mouse 100.

The sensing module 12 in the present embodiment includes an electromyography (EMG) sensor 121, a motion sensor 122, and an inertial sensor 123, but the present disclosure is not limited thereto. For example, in other embodiments of the present disclosure not shown in the drawings, the inertial sensor 123 can be omitted or can be replaced by other components according to practical requirements.

Specifically, the EMG sensor 121 is assembled in the housing 11 and faces toward an inner side of the housing 11. In other words, the EMG sensor 121 of the present embodiment is assembled to the outer wrist segment 111 for detecting a movement of the wrist, but the present disclosure is not limited thereto. Accordingly, when the bracelet mouse 100 is worn on the wrist, the EMG sensor 121 is configured to detect gesture changes of the user.

Moreover, the inertial sensor 123 is assembled in the housing 11, and the inertial sensor 123 is in cooperation with the EMG sensor 121 for being configured to jointly detect the gesture changes of the user. The inertial sensor 123 can include at least one of multi-axis gyroscopes, multi-direction accelerometers, and magnetometers, but a specific configuration of the inertial sensor 123 can be adjusted or changed according to practical requirements and is not limited thereto.

The motion sensor 122 is assembled in the ulna segment 112 and faces toward an outer side of the housing 11. As shown in FIG. 1 to FIG. 4, when the bracelet mouse 100 is worn on the wrist, the ulna segment 112 and the motion sensor 122 are located adjacent to the ulna of the wrist, the ulna segment 112 is configured to move on a working surface P along a movement path, and the motion sensor 122 is configured to obtain the movement path of the ulna segment 112 (or the bracelet mouse 100).

The EMG sensor 121, the motion sensor 122, and the inertial sensor 123 of the bracelet mouse 100 are wirelessly connected to the processing device 200, such that the processing device 200 is configured to control the cursor 301 of the display 300 through the EMG sensor 121, the motion sensor 122, and the inertial sensor 123.

Accordingly, the detection machine 1 of the bracelet mouse 100 in the present embodiment is provided with the housing 11 having the wearing angle σ11 for being easily worn on the wrist of the user, so that the user can control the bracelet mouse 100 by using the wrist for freeing both hands.

Moreover, the bracelet mouse 100 in the present embodiment not only includes the EMG sensor 121, but also includes the motion sensor 122 assembled to the ulna segment 112 that is movable on the working surface P, so that the bracelet mouse 100 (or the detection machine 1) can be operated (to control the cursor 301) through the gesture changes of the user and the movement path of the ulna segment 112.

It should be noted that the processing device 200 in the present embodiment is a host of a notebook computer, and the display 300 is a screen of the notebook computer, but the present disclosure is not limited thereto. For example, in other embodiments of the present disclosure not shown in the drawings, the processing device 200 can be a desktop computer, and the display 300 can be a screen or a projection mechanism that is electrically coupled to the desktop computer.

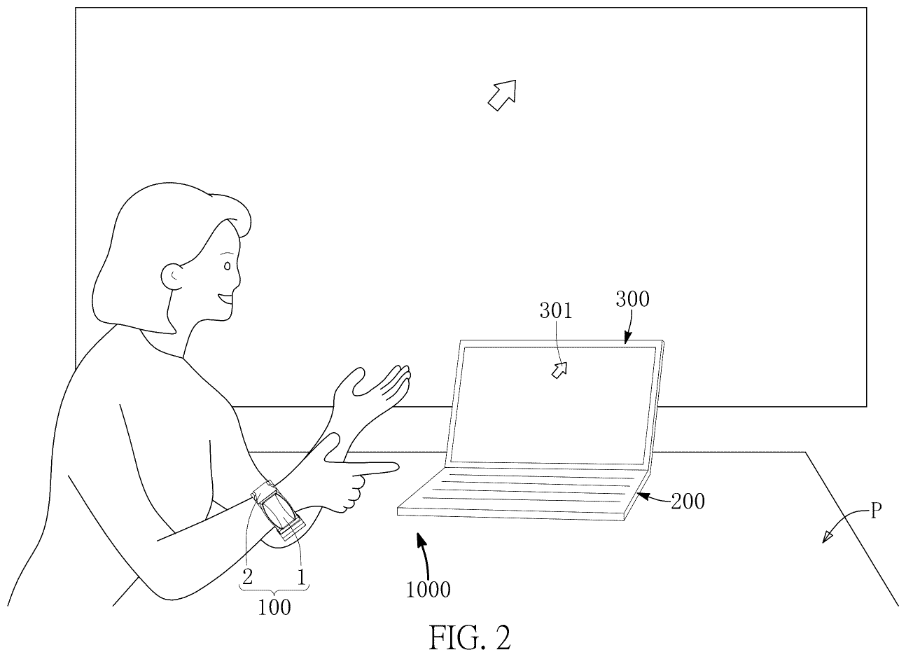

In summary, as shown in FIG. 1 to FIG. 4, when the bracelet mouse 100 is worn on the wrist, the bracelet mouse 100 is in a mouse control mode (as shown in FIG. 1) by placing the ulna segment 112 onto the working surface P, or in a gesture control mode (as shown in FIG. 2) by separating the ulna segment 112 from the working surface P.

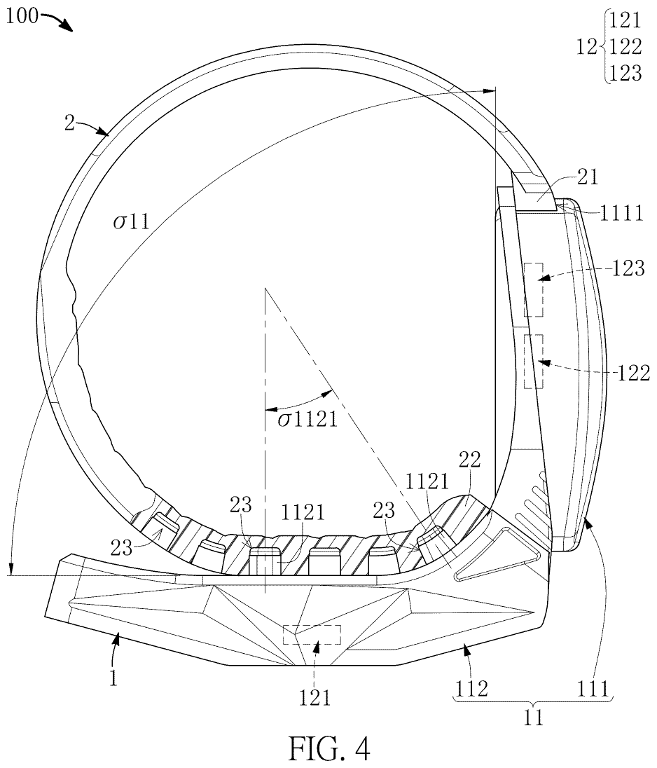

Specifically, when the bracelet mouse 100 is worn on the wrist and is in the mouse control mode (as shown in FIG. 1 and FIG. 4), the processing device 200 is configured to control the cursor 301 of the display 300 through the gesture changes obtained by the EMG sensor 121 and the movement path obtained by the motion sensor 122.

Moreover, when the bracelet mouse 100 is worn on the wrist and is in the gesture control mode (as shown in FIG. 2 and FIG. 4), the processing device 200 is configured to control the cursor 301 of the display 300 through the gesture changes obtained by the EMG sensor 121, and the motion sensor 122 is spaced apart from the working surface P and is not in operation for the cursor 301.

### Second Embodiment

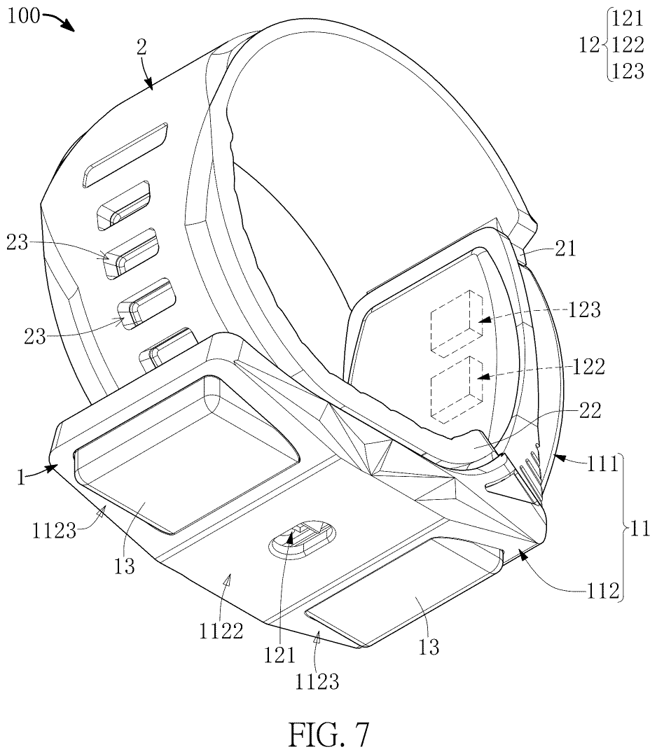

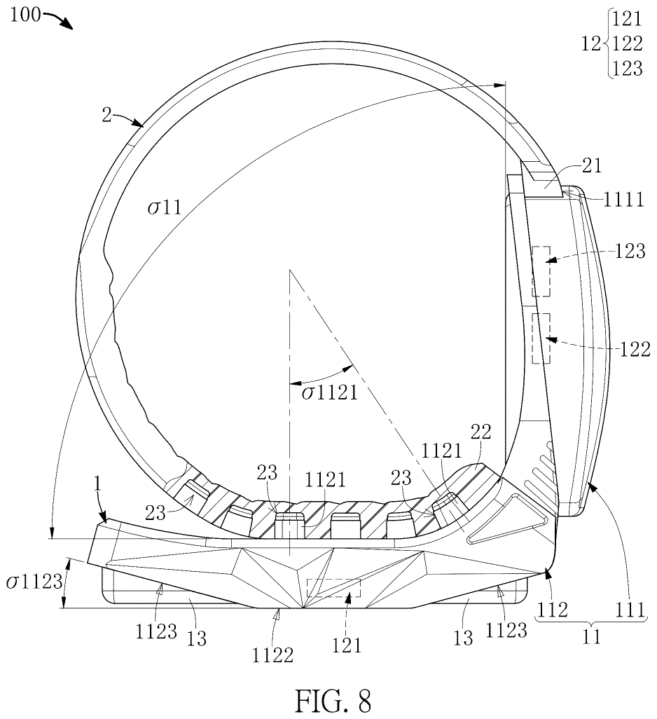

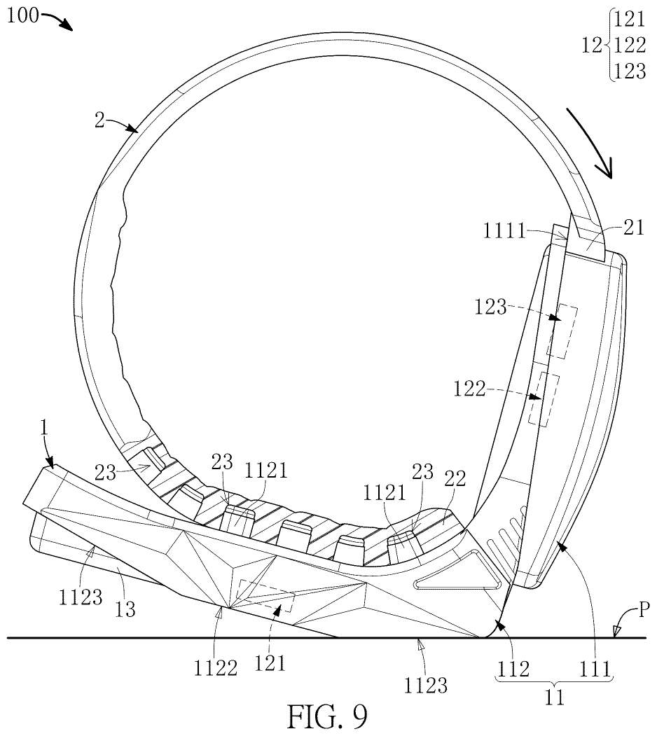

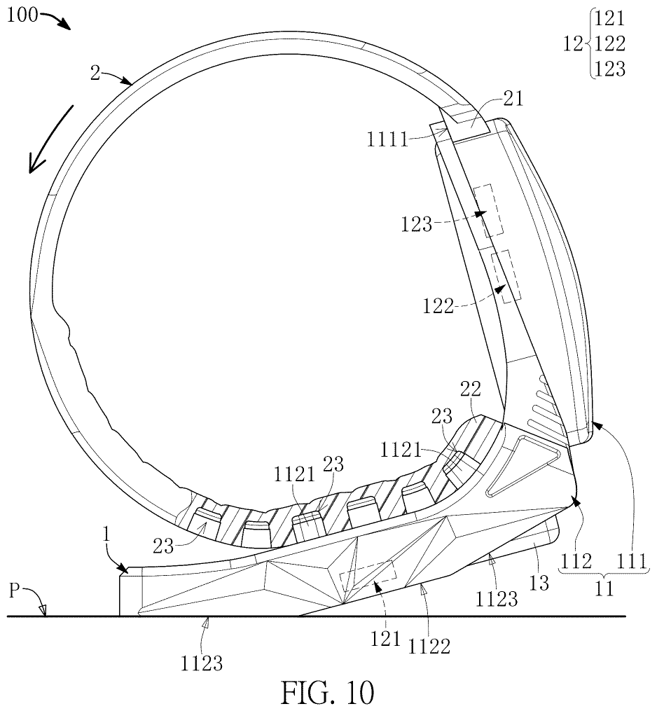

Referring to FIG. 7 to FIG. 10, a second embodiment of the present disclosure, which is similar to the first embodiment of the present disclosure, is provided. For the sake of brevity, descriptions of the same components in the first and second embodiments of the present disclosure will be omitted herein, and the following description only discloses different features between the first and second embodiments.

In the present embodiment, the detection machine 1 includes a plurality of buttons 13 that are assembled to the ulna segment 112 and that are respectively arranged at two opposite sides of the motion sensor 122. Any one of the buttons 13 can be provided for implementing a function of a left button or a right button of a conventional mouse or implementing a function of a shortcut button of a keyboard according to practical requirements, thereby effectively increasing convenience of the bracelet mouse 100, but the present disclosure is not limited thereto.

Specifically, the cooperation of the buttons 13 and the ulna segment 112 can be adjusted or changed according to practical requirements, and in order to clearly describe the present embodiment, the following description describes one possible example of the cooperation of the buttons 13 and the ulna segment 112, but the present disclosure is not limited thereto.

The ulna segment 112 has an abutting surface 1122 for abutting against the working surface P and a plurality of slanting surfaces 1123 that are connected to two opposite sides of the abutting surface 1122. In the present embodiment, the motion sensor 122 faces toward the outside of the ulna segment 112 through the abutting surface 1122, and the slanting surfaces 1123 are substantially in a mirror symmetrical arrangement relative to the abutting surface 1122. A triggering angle σ1123 between an extension surface of the abutting surface 1122 and each of the slanting surfaces 1123 is less than or equal to 30 degrees for facilitating a rotation of the wrist.

Moreover, each of the buttons 13 corresponds in position to one of the slanting surfaces 1123, one of the buttons 13 is arranged adjacent to the outer wrist segment 111, and another one of the buttons 13 is arranged away from the outer wrist segment 111. Each of the buttons 13 is substantially arranged in a space defined by the one of the slanting surfaces 1123 and the extension surface of the abutting surface 1122, thereby preventing any one of the buttons 13 from being accidentally touched.

In summary, when the bracelet mouse 100 is worn on the wrist and is in the mouse control mode, the bracelet mouse 100 is rotatable toward one side of the motion sensor 122 so as to press a corresponding one of the buttons 13 through the working surface P (e.g., the bracelet mouse 100 is configured to rotate at least one of the slanting surfaces 1123 toward the working surface P by an angle that is less than or equal to the triggering angle σ1123, such that the corresponding button 13 is pressed through the working surface P).

It should be noted that a quantity of the buttons 13 and a quantity of the corresponding structures (e.g., the slanting surfaces 1123) in the detection machine 1 provided by the present embodiment can each be two, but the present disclosure is not limited thereto. For example, in other embodiments of the present disclosure not shown in the drawings, a quantity of the buttons 13 and a quantity of the slanting surfaces 1123 in the detection machine 1 can each be at least one, in which the at least one button 13 is arranged adjacent to the motion sensor 122 and corresponds in position to the at least one slanting surface 1123, and the at least one button 13 is located in a space defined by the at least one slanting surface 1123 and the extension surface of the abutting surface 1122. Moreover, when the bracelet mouse 100 is worn on the wrist and is in the mouse control mode, the bracelet mouse 100 is configured to rotate the at least one slanting surface 1123 toward the working surface P, such that the at least one button 13 is pressed through the working surface P.

### Beneficial Effects of the Embodiments

In conclusion, the detection machine of the bracelet mouse in the present disclosure is provided with the housing having the wearing angle for being easily worn on the wrist of the user, so that the user can control the bracelet mouse by using the wrist for freeing both hands.

Moreover, the bracelet mouse in the present disclosure not only includes the EMG sensor, but also includes the motion sensor assembled to the ulna segment that is movable on the working surface, so that the bracelet mouse (or the detection machine) can be operated through the gesture changes of the user and the movement path of the ulna segment.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic operation system, comprising:
a bracelet mouse including:
a detection machine including:
a housing having an outer wrist segment and an ulna segment connected to the outer wrist segment, wherein a wearing angle between the outer wrist segment and the ulna segment is within a range from 80 degrees to 100 degrees;
an electromyography (EMG) sensor assembled in the housing and facing toward an inner side of the housing; and
a motion sensor assembled in the ulna segment and facing toward an outer side of the housing; and
a wristband detachably assembled to the outer wrist segment and the ulna segment of the housing, wherein the bracelet mouse is configured to be worn on a wrist of a user through the outer wrist segment and the wristband so as to enable the ulna segment and the motion sensor to be located adjacent to an ulna of the wrist;
wherein, when the bracelet mouse is worn on the wrist, the EMG sensor is configured to detect gesture changes of the user, the ulna segment is configured to move on a working surface along a movement path, and the motion sensor is configured to obtain the movement path;
a processing device wirelessly connected to the EMG sensor and the motion sensor of the bracelet mouse; and
a display electrically coupled to the processing device, wherein, when the bracelet mouse is worn on the wrist, the processing device is configured to control a cursor of the display through the EMG sensor and the motion sensor.

2. The electronic operation system according to claim 1, wherein the outer wrist segment has an assembling slot arranged away from the ulna segment, the ulna segment has at least one positioning protrusion arranged on an inner side thereof, and the wristband has:
a first end portion detachably assembled to the assembling slot of the outer wrist segment;
a second end portion being opposite to the first end portion; and
a plurality of adjustment holes arranged along a direction from the second end portion toward the first end portion, wherein the at least one positioning protrusion is detachably assembled to at least one of the adjustment holes.

3. The electronic operation system according to claim 2, wherein the at least one positioning protrusion is further limited to be two positioning protrusions that are detachably assembled to any two of the adjustment holes, and wherein one of the two positioning protrusions is adjacent to the outer wrist segment and is slanted relative to another one of the two positioning protrusions, and a positioning angle between extension directions of the two positioning protrusions is less than or equal to 45 degrees.

4. The electronic operation system according to claim 1, wherein the detection machine includes an inertial sensor assembled in the housing, and wherein the inertial sensor is in cooperation with the EMG sensor for being configured to jointly detect the gesture changes of the user.

5. The electronic operation system according to claim 1, wherein, when the bracelet mouse is worn on the wrist, the bracelet mouse is in a mouse control mode by placing the ulna segment onto the working surface, or in a gesture control mode by separating the ulna segment from the working surface.

6. The electronic operation system according to claim 5, wherein, when the bracelet mouse is worn on the wrist and is in the mouse control mode, the processing device is configured to control the cursor of the display through the gesture changes obtained by the EMG sensor and the movement path obtained by the motion sensor.

7. The electronic operation system according to claim 5, wherein, when the bracelet mouse is worn on the wrist and is in the gesture control mode, the processing device is configured to control the cursor of the display through the gesture changes obtained by the EMG sensor, and the motion sensor is spaced apart from the working surface and is not in operation for the cursor.

8. The electronic operation system according to claim 5, wherein the detection machine includes a plurality of buttons that are assembled to the ulna segment and that are respectively arranged at two opposite sides of the motion sensor, and wherein, when the bracelet mouse is worn on the wrist and is in the mouse control mode, the bracelet mouse is configured to selectively rotate to any one of the two opposite sides of the motion sensor for pressing a corresponding one of the buttons through the working surface.

9. The electronic operation system according to claim 8, wherein the ulna segment has:
an abutting surface for abutting against the working surface, wherein the motion sensor faces toward an outside of the ulna segment through the abutting surface; and
a plurality of slanting surfaces, wherein a triggering angle between an extension surface of the abutting surface and each of the slanting surfaces is less than or equal to 30 degrees, and each of the buttons corresponds in position to one of the slanting surfaces and is substantially arranged in a space defined by the one of the slanting surfaces and the extension surface of the abutting surface;
wherein, when the bracelet mouse is worn on the wrist and is in the mouse control mode, the bracelet mouse is configured to selectively rotate one of the slanting surfaces toward the working surface by an angle that is less than or equal to the triggering angle, such that a corresponding one of the buttons is pressed through the working surface.

10. The electronic operation system according to claim 8, wherein one of the buttons is arranged adjacent to the outer wrist segment, and another one of the buttons is arranged away from the outer wrist segment.

11. The electronic operation system according to claim 5, wherein the detection machine includes at least one button that is assembled to the ulna segment and that is arranged adjacent to the motion sensor, and wherein, when the bracelet mouse is worn on the wrist and is in the mouse control mode, the bracelet mouse is rotatable to press the at least one button through the working surface.

12. The electronic operation system according to claim 11, wherein the ulna segment has:
an abutting surface for abutting against the working surface, wherein the motion sensor faces toward an outside of the ulna segment through the abutting surface; and
at least one slanting surface, wherein a triggering angle between an extension surface of the abutting surface and the at least one slanting surface is less than or equal to 30 degrees, and the at least one button corresponds in position to the at least one slanting surface and is substantially arranged in a space defined by the at least one slanting surface and the extension surface of the abutting surface;
wherein, when the bracelet mouse is worn on the wrist and is in the mouse control mode, the bracelet mouse is configured to rotate the at least one slanting surface toward the working surface by an angle that is less than or equal to the triggering angle, such that the at least one button is pressed through the working surface.

13. A bracelet mouse, comprising:
a detection machine including:
a housing having an outer wrist segment and an ulna segment connected to the outer wrist segment, wherein a wearing angle between the outer wrist segment and the ulna segment is within a range from 80 degrees to 100 degrees;
an electromyography (EMG) sensor assembled in the housing and facing toward an inner side of the housing; and
a motion sensor assembled in the ulna segment and facing toward an outer side of the housing; and
a wristband detachably assembled to the outer wrist segment and the ulna segment of the housing, wherein the bracelet mouse is configured to be worn on a wrist of a user through the outer wrist segment and the wristband so as to enable the ulna segment and the motion sensor to be located adjacent to an ulna of the wrist;
wherein, when the bracelet mouse is worn on the wrist, the EMG sensor is configured to detect gesture changes of the user, the ulna segment is configured to move on a working surface along a movement path, and the motion sensor is configured to obtain the movement path.

14. The bracelet mouse according to claim 13, wherein, when the bracelet mouse is worn on the wrist, the bracelet mouse is in a mouse control mode by placing the ulna segment onto the working surface, or in a gesture control mode by separating the ulna segment from the working surface.

15. The bracelet mouse according to claim 14, wherein the detection machine includes a plurality of buttons that are assembled to the ulna segment and that are respectively arranged at two opposite sides of the motion sensor, and wherein, when the bracelet mouse is worn on the wrist and is in the mouse control mode, the bracelet mouse is configured to selectively rotate to any one of the two opposite sides of the motion sensor for pressing a corresponding one of the buttons through the working surface.

16. The bracelet mouse according to claim 15, wherein the ulna segment has:
an abutting surface for abutting against the working surface, wherein the motion sensor faces toward the outside of the ulna segment through the abutting surface; and
a plurality of slanting surfaces, wherein a triggering angle between an extension surface of the abutting surface and each of the slanting surfaces is less than or equal to 30 degrees, and each of the buttons corresponds in position to one of the slanting surfaces and is substantially arranged in a space defined by the one of the slanting surfaces and the extension surface of the abutting surface;
wherein, when the bracelet mouse is worn on the wrist and is in the mouse control mode, the bracelet mouse is configured to selectively rotate one of the slanting surfaces toward the working surface by an angle that is less than or equal to the triggering angle, such that a corresponding one of the buttons is pressed through the working surface.

17. The bracelet mouse according to claim 13, wherein the outer wrist segment has an assembling slot arranged away from the ulna segment, and the ulna segment has two positioning protrusions arranged on an inner side thereof, wherein one of the two positioning protrusions is adjacent to the outer wrist segment and is slanted relative to another one of the two positioning protrusions, and a positioning angle between extension directions of the two positioning protrusions is less than or equal to 45 degrees, and wherein the wristband has:
a first end portion detachably assembled to the assembling slot of the outer wrist segment;
a second end portion being opposite to the first end portion; and
a plurality of adjustment holes arranged along a direction from the second end portion toward the first end portion, wherein the two positioning protrusions are detachably assembled to any two of the adjustment holes.

18. A detection machine of a bracelet mouse, comprising:
a housing having an outer wrist segment and an ulna segment connected to the outer wrist segment, wherein a wearing angle between the outer wrist segment and the ulna segment is within a range from 80 degrees to 100 degrees;
an electromyography (EMG) sensor assembled in the housing and facing toward an inner side of the housing; and
a motion sensor assembled in the ulna segment and facing toward an outer side of the housing, wherein the ulna segment is configured to move on a working surface along a movement path, and the motion sensor is configured to obtain the movement path.

19. The detection machine according to claim 18, wherein the outer wrist segment has an assembling slot arranged away from the ulna segment, and the ulna segment has two positioning protrusions arranged on an inner side thereof, and wherein one of the two positioning protrusions is adjacent to the outer wrist segment and is slanted relative to another one of the two positioning protrusions, and a positioning angle between extension directions of the two positioning protrusions is less than or equal to 45 degrees.

20. The detection machine according to claim 18, further comprising an inertial sensor assembled in the housing, wherein the inertial sensor is in cooperation with the EMG sensor for being configured to jointly detect the gesture changes of the user.
